(19) United States
(12) Patent Application Publication
(10) Pub. No.: US 2014/0139135 A1
(43) Pub. Date: May 22, 2014

(54) ILLUMINATION APPARATUS

(71) Applicant: KABUSHIKI KAISHA TOSHIBA, Tokyo (JP)

(72) Inventors: Kanako SAITO, Kanagawa (JP); Toshimitsu KANEKO, Kanagawa (JP); Yoshie IMAI, Tokyo (JP); Hisashi KOBIKI, Kanagawa (JP)

(73) Assignee: KABUSHIKI KAISHA TOSHIBA, Tokyo (JP)

(21) Appl. No.: 14/077,523

(22) Filed: Nov. 12, 2013

(30) Foreign Application Priority Data
Nov. 20, 2012 (JP) 2012-254167

(51) Int. Cl. H05B 37/02

(52) U.S. Cl. CPC H05B 37/02
USPC 315/292

(57) ABSTRACT

According to an embodiment, an illumination apparatus includes a light source that emits at least two types of lights having different spectral distributions and a controller. The controller starts controlling of the light source. The controller sequentially performs switching-controlling of pre-set lighting-up patterns of the light source so as to switch at least one of a combination of the lights having different spectral distributions of the light source and a combination of intensities of the light source in response to the start of the control of the light source. The controller ends controlling of the light source after at least the switching-controlling of all the pre-set lighting-up patterns of the light source is performed.

### CROSS-REFERENCE TO RELATED APPLICATION

This application is based upon and claims the benefit of priority from Japanese Patent Application No. 2012-254167, filed on Nov. 20, 2012; the entire contents of which are incorporated herein by reference.

### FIELD

Embodiments described herein relate generally to an illumination apparatus.

### BACKGROUND

Conventionally, there is a technique for optimizing a spectral filter under an arbitrary illumination light environment so as to emphasize a difference in spectral reflectance between illuminated objects. If the difference in spectral reflectance between the illuminated objects can be emphasized, a difference in color between objects having similar colors can be identified.

In some cases of illuminated objects, the difference in spectral reflectance may be large among individual persons or objects. In the case of the illuminated objects having a large difference in spectral reflectance among individual persons or objects, it is difficult to uniquely determine a parameter optimized to the spectral filter.

### BRIEF DESCRIPTION OF THE DRAWINGS

FIG. 1 is a block diagram illustrating a configuration of an illumination apparatus according to a first embodiment;

FIG. 2 is a diagram illustrating a mirror to which an illumination apparatus is applied;

FIG. 3A is a diagram illustrating spectral reflectance of portions of a person;

FIG. 3B is a diagram illustrating spectral reflectance of portions of another person;

FIG. 4 is a diagram illustrating spectral reflectance of the cases where different cosmetics are applied to a bare skin of a person;

FIG. 5 is a flowchart illustrating a procedure of a light source control process according to the first embodiment;

FIG. 6 is a block diagram illustrating a configuration of an illumination apparatus according to a second embodiment;

FIG. 7 is a flowchart illustrating a procedure of a light source control process according to the second embodiment;

FIG. 8 is a block diagram illustrating a configuration of an illumination apparatus according to a third embodiment;

FIG. 9 is a flowchart illustrating a procedure of a light source control process according to the third embodiment;

FIG. 10 is a block diagram illustrating a configuration of an illumination apparatus according to a fourth embodiment; and

FIG. 11 is a flowchart illustrating a procedure of a light source control process according to the fourth embodiment.

### DETAILED DESCRIPTION

According to an embodiment, an illumination apparatus includes a light source that emits at least two types of lights having different spectral distributions and a controller. The controller starts controlling of the light source. The controller sequentially performs switching-controlling of pre-set lighting-up patterns of the light source so as to switch at least one of a combination of the lights having different spectral distributions of the light source and a combination of intensities of the light source in response to the start of the control of the light source. The controller ends controlling of the light source after at least the switching-controlling of all the pre-set lighting-up patterns of the light source is performed.

### First Embodiment

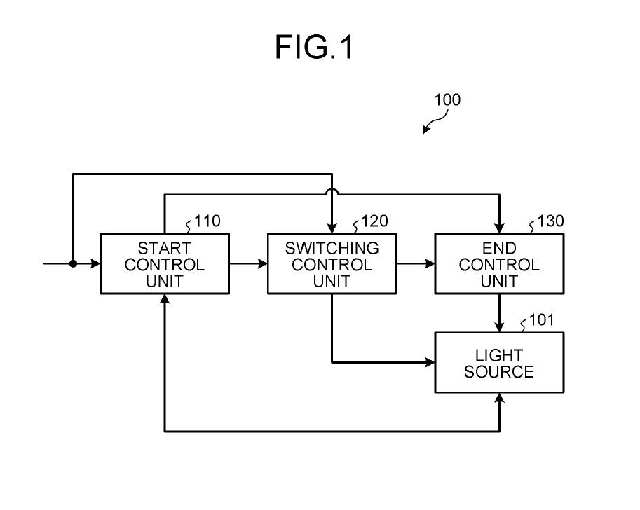

FIG. 1 is a block diagram illustrating an example of a configuration of an illumination apparatus according to a first embodiment. As illustrated in FIG. 1, an illumination apparatus 100 is configured to include light source 101, a start control unit 110, a switching control unit 120, and an end control unit 130.

The light source 101 emit at least two types of light beams having different spectral distributions according to control of the switching control unit 120. At least two types of the light beams having different spectral distributions denote that spectral characteristics of two types or more of illumination light beams are different from each other. For example, each light source 101 is a light emitting diode (LED) illuminant, organic electro-luminescence (EL) illuminant, a dimming-controlled fluorescent lamp, or the like.

The state where the control is not performed by the switching control unit 120 is set as a lighted-out state or a predetermined illumination lighted-up state. The predetermined illuminant denotes an illuminant used for daily life, work or the like. For example, the predetermined illuminant is a standard or auxiliary illuminant defined by Japanese Industrial Standard (JIS) Z8720 or an illuminant having spectral reflectance of a representative fluorescent lamp defined by JIS Z8719.

The start control unit 110 starts controlling the light source 101. More specifically, in the case where the start control unit 110 receives a start signal indicating a signal for start controlling the light source 101, the start control unit 110 instructs the switching control unit 120 to start controlling the light source 101. The start signal is input according to user's manipulation using a switch arranged in the illumination apparatus 100 or a remote controller or the like for manipulating the illumination apparatus 100. In addition, the start control unit 110 acquires a state of the light source 101 of the time when the start signal is received and notifies the acquired state of the light source 101 to the end control unit 130. The state of the light source 101 is information indicating a lighted-out state or information indicating which one of lighted-up states it is. As described above, when the light source 101 is not controlled by the switching control unit 120, the state of the light source 101 becomes a lighted-out state or a lighted-up state of a predetermined illuminant.

The switching control unit 120 sequentially performs switching control of switching at least one of a combination of the light source 101 having different spectral distributions and intensities of individual light source 101 according to the instruction of starting the controlling by the start control unit 110. More specifically, the switching control unit 120 sequentially performs the switching control so that a difference in color perceived by a person is changed between first and second illuminated objects having different color, which are illuminated objects of the light source 101. The switching timing in the switching control is a time interval when a person can identify the difference in color between the illuminated objects, for example, a certain time interval of 5 seconds or the like. As the switching control is sequentially performed, the illumination of the light source 101 is sequentially changed into different spectral distributions. In the embodiment, a plurality of different spectral distributions which are defined in advance according to the use of the illumination are used.

The illumination of the illumination apparatus 100 according to the embodiment is used in order for a user to easily visually identify first and second illuminated objects, which have similar colors and are difficult to identify a difference in color under general illumination, by changing the difference in color with a plurality of illumination light beams having different spectral distributions. For example, like the case of no-cosmetic-applied skin (first illuminated object) and cosmetic-applied skin (second illuminated object), the illumination of the illumination apparatus 100 is used in order to identify objects which actually have different colors but are difficult to identify the difference in color under general illumination.

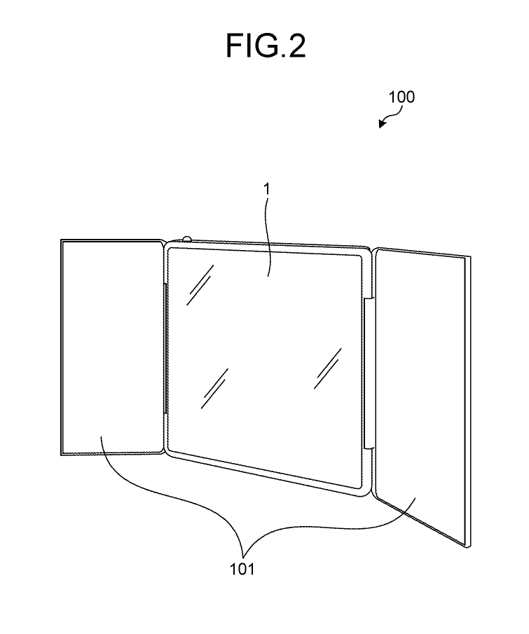

FIG. 2 is a diagram illustrating an example of a mirror to which the illumination apparatus 100 is applied. As illustrated in FIG. 2, in a mirror 1 to which the illumination apparatus 100 is applied, the light source 101 is installed at two sides of the mirror 1. After a user applies a cosmetic on user's skin, the user inputs a start signal by using a switch or a remote controller and checks the user's skin, which is illuminated with illumination light beams of the light source 101 of which switching control is sequentially performed, with the mirror 1 to determine whether or not there is an uneven portion.

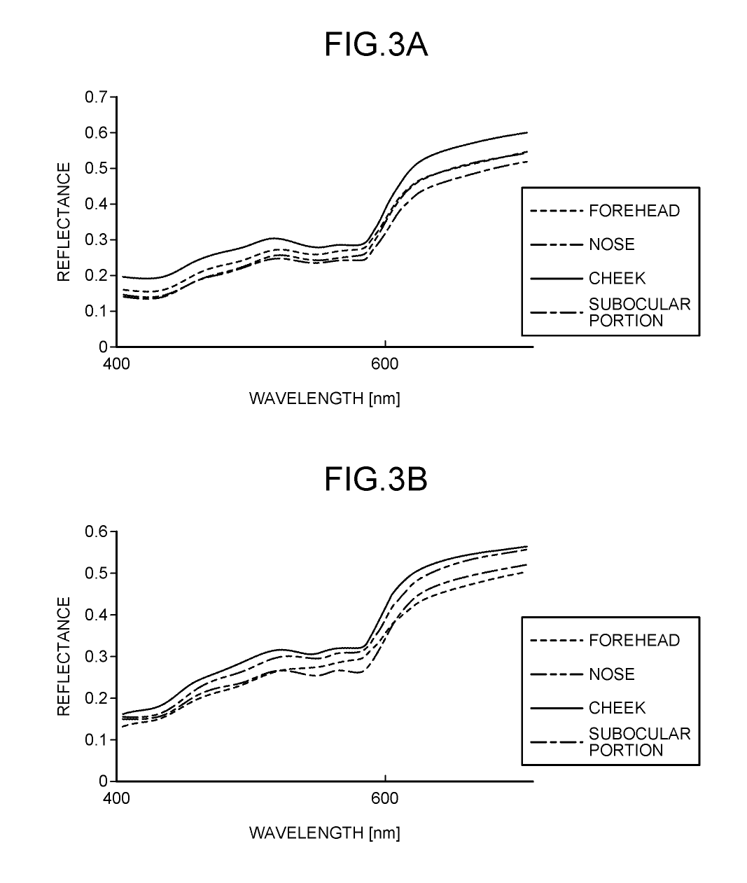

FIG. 3A is a diagram illustrating an example of spectral reflectance of portions of a person. FIG. 3B is a diagram illustrating an example of spectral reflectance of portions of a person who is different from the person illustrated in FIG. 3A. In FIGS. 3A and 3B, the vertical axes denote spectral reflectance, and the horizontal axes denote wavelength. With respect to portions of a person, a forehead is indicated by a broken line, a nose is indicated by a two-dot dashed line, a cheek is indicated by a solid line, and a lower eyelid is indicated by a dot dashed line. It can be understood from FIGS. 3A and 3B that, in the case of the spectral reflectance of the skin which is not applied with a cosmetic, the spectral reflectance of the same person is different according to a portion of the face (a forehead, a nose, a cheek, a lower eyelid). In addition, it can be understood that the tendency of the spectral reflectance is different among persons.

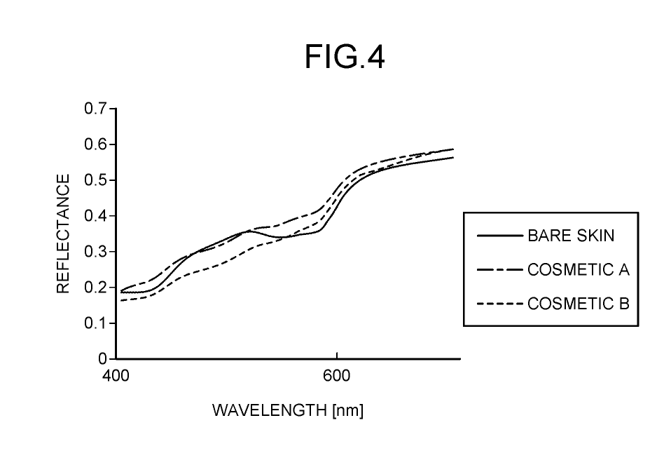

FIG. 4 is a diagram illustrating an example of spectral reflectance of a bare skin of a person and spectral reflectance of the cases where different cosmetics are applied to the bare skin of the person. In FIG. 4, the vertical axis denotes spectral reflectance, and the horizontal axis denotes wavelength. A bare skin of a person is indicated by a solid line; a cosmetic “A” is indicated by a dot dashed line; and a cosmetic “B” is indicated by a broken line. It can be understood from FIG. 4 that, in the case of the spectral reflectance of a skin which is applied with different cosmetics, the spectral reflectance of the same person is different according to the difference of the cosmetics. In addition, it can be understood from the comparison of the bare skin and the cosmetic-applied skins that the wavelength bands where the difference occurs are different. In other words, similarly to the case of the no-cosmetic-applied skin and the cosmetic-applied skin, in the case where the difference in the spectral reflectance of the objects is very large among individual persons, it is difficult to uniquely determine optimized parameters of the spectral filter in the conventional apparatus.

In this manner, for example, the spectral reflectance of the cosmetic-applied skin and the spectral reflectance of the no-cosmetic-applied skin are different among individual persons or cosmetics, and the spectral reflectance of the same person is different according to the portions of the face. Therefore, plural types of combination of the light source are set in advance. However, the user cannot determine which setting of illumination is appropriate until the user actually irradiates the user's skin with illumination light beams. Therefore, all the illumination light beams according to the plural types of settings which are set in advance are allowed to be checked by the user.

Herein, a method of obtaining illumination for facilitating user's identification of the first and second illuminated objects will be described. For example, in a U*V*W* color space, an equivalent color space such as the CIE 1976 L*a*b* color space, the CIE Δ94 L*a*b* color space, and the CIE DE2000 L*a*b* color space, or a CIE CAM02 color space considering adaptability defined by the International Commission on Illumination (CIE), the illumination is obtained based on a difference in color between the first and second illuminated objects. In the case of an L*a*b* color space, the difference in color is obtained based on color difference ΔE*ab which is a distance between two points, a distance between two points in an a*b* space, or a difference in a hue angle between two points in the a*b* space.

Next, a method of calculating the color of the first illuminated object and the color of the second illuminated object will be described. Herein, in the description, the case of using an L*a*b* color space is exemplified. The tristimulus values X, Y, and Z of the illuminated object are obtained by Equation (1) using a spectral distribution P(λ) of an illumination light beam, a spectral reflectance R(λ) of the illuminated object, and a color-matching function. In Equation (1), k is expressed by Equation (2). In addition, integral “∫ᵥᵢₛ” is taken over a wavelength range of visible light. Next, chromaticity coordinates in the L*a*b* color space are obtained from tristimulus values X, Y, and Z by using a transformation formula defined by the International Commission on Illumination.

$$[ \begin{matrix}\begin{matrix}X \\ Y\end{matrix} \\ Z\end{matrix} ] = k {\int }_{vis} R ( λ ) \cdot P ( λ ) \cdot [ \begin{matrix}\overline{x} ( λ ) \\ \overline{y} ( λ ) \\ \overline{z} ( λ )\end{matrix} ] d λ \qquad ( 1 )$$

Herein, x̅(λ), y̅(λ), z̅(λ) represent color-matching functions.

k=100/∫ᵥᵢₛP(λ) y̅(λ)dλ (2)

The illumination which allows the user to easily identify the first illuminated object and the second illuminated object is set by combining a plurality of light source having different peak wavelengths and calculating a difference in color for each wavelength of the illumination which is to be generated, so that the combination having maximum difference in color is set. In addition, in the case where plural pairs of the first illuminated objects and the second illuminated objects exit, the illumination with respect to each pair may be obtained, and a plurality of representative illuminations may be obtained from the illumination obtained with respect to each pair by using a clustering method, a principal component analysis method, or the like. In other words, the appropriate number of representative illuminations may be configured according to the use of illumination, for example, so that a long time is not needed. Therefore, even in the case of the illuminated objects where the difference in spectral reflectance exists among individual persons or objects, it is possible to easily identify the difference in color by using at least one of the illumination light beams without the influence of the above-described difference in spectral reflectance exists among individual persons or objects.

The switching control unit 120 which sequentially performs the switching control of the illumination light beams ends the switching control and transmits an end signal indicating that the switching control is ended to the end control unit 130. The ending of the switching control and the transmitting of the end signal may be performed at a time when the a sequence of the lighting-up of the illumination according to the sequential performance of the switching control is ended, or may be performed at a pre-set time, according to a pre-set number of switching, or the like. Besides, in the case where an instruction for ending the switching control is received through user's manipulation, the end signal may be transmitted. However, it is preferable that the transmitting of the end signal be performed at the timing after at least one sequence of the switching control is completed so that the user can identify the difference in color with respect to the illuminated objects. Therefore, if the ending instruction is received through the user's manipulation before the one sequence of the switching control is completed, the end signal is transmitted after the one sequence of the switching control is completed.

Alternatively, if the ending instruction is received through the user's manipulation before the one sequence of the switching control is completed, the user's manipulation may be determined to be invalid.

The end control unit 130 ends the control of the light source 101. More specifically, in the case where the end control unit 130 receives an end signal from the switching control unit 120, the end control unit 130 ends control of the light source 101. At this time, the end control unit 130 returns the light source 101 to the state of the light source 101 notified by the start control unit 110. The state of the light source 101 notified by the start control unit 110 denotes a lighted-out state or a lighted-up state of a predetermined illumination. In other words, when the switching control process for the light source 101 by the switching control unit 120 is completed, the end control unit 130 returns the light source 101 to the state before the switching control process is performed.

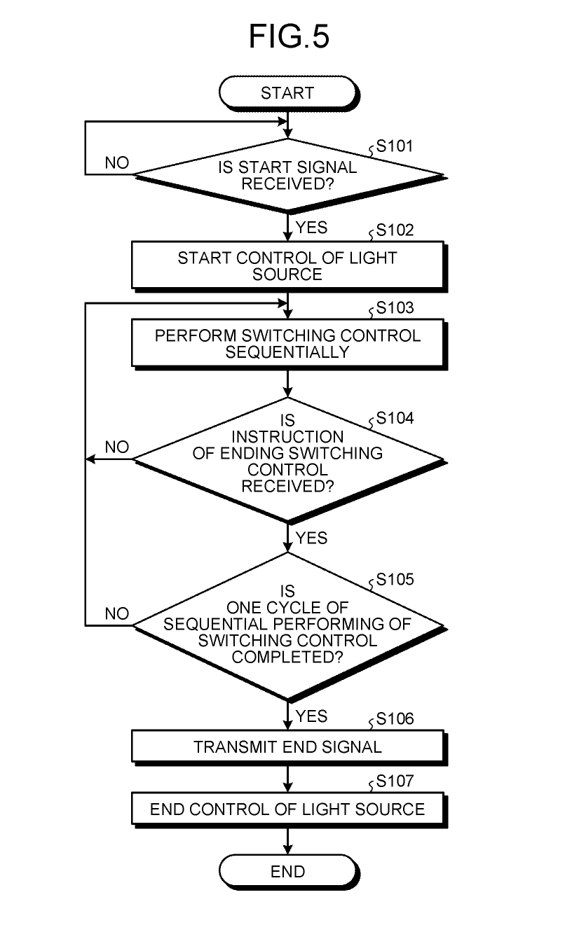

Next, a procedure of a light source control process according to the first embodiment will be described with reference to FIG. 5. FIG. 5 is a flowchart illustrating an example of a procedure of a light source control process according to the first embodiment. FIG. 5 exemplifies the case where an instruction of ending switching control according to user's manipulation is received.

As illustrated in FIG. 5, in the case where the start control unit 110 receives a start signal for start controlling the light source 101 (Yes in Step S101), the start control unit 110 instructs the switching control unit 120 to start controlling the light source 101 (Step S102). At this time, the start control unit 110 notifies the state of the light source 101 to the end control unit 130. On the other hand, in the case where the start control unit 110 does not receive the start signal (No in Step S101), the start control unit 110 is in a state of standing by reception of the start signal.

The switching control unit 120 sequentially performs switching control of switching a combination of the light source 101 having different spectral distributions or intensities of the light source 101 according to the instruction of starting the control of the light source 101 by the start control unit 110 (Step S103). When the switching control unit 120 sequentially performs the switching control, the switching control unit 120 determines whether or not an instruction of ending the switching control according to user's manipulation is received (Step S104). In the case where the instruction of ending the switching control is received (Yes in Step S104), the switching control unit 120 determines whether or not one cycle of the sequential performing of the switching control is completed (Step S105). On the other hand, in the case where the instruction of ending the switching control is not received (No in Step S104), the switching control unit 120 continues to sequentially perform the switching control (Step S103).

In addition, in the case where it is determined that one cycle of the sequential performing of the switching control is completed (Yes in Step S105), the switching control unit 120 ends the switching control and transmits an end signal indicating that the switching control is ended to the end control unit 130 (Step S106). On the other hand, in the case where it is determined that one cycle of the sequential performing of the switching control is not completed (No in Step S105), the switching control unit 120 continues to sequentially perform the switching control (Step S103). However, since the instruction of ending the switching control is received, when the one cycle of the sequential performing of the switching control is completed, the switching control unit 120 ends the switching control and transmits the end signal to the end control unit 130. In the case where the end control unit 130 receives the end signal from the switching control unit 120, the end control unit 130 returns the light source 101 to the state notified by the start control unit 110 and ends the control of the light source 101 (Step S107).

According to the embodiment, in the light source 101 which irradiate the illuminated object with light beams so that the difference in color according to human perception is changed, since the switching control of switching to a combination of other light source 101 is sequentially performed, it is possible for a user to easily identify the difference in color with respect to the illuminated objects having similar colors. In addition, according to the embodiment, since the end signal is transmitted after one cycle of the switching control is completed, the user can check the illumination light beams corresponding to all the settings which are set in advance.

### Second Embodiment

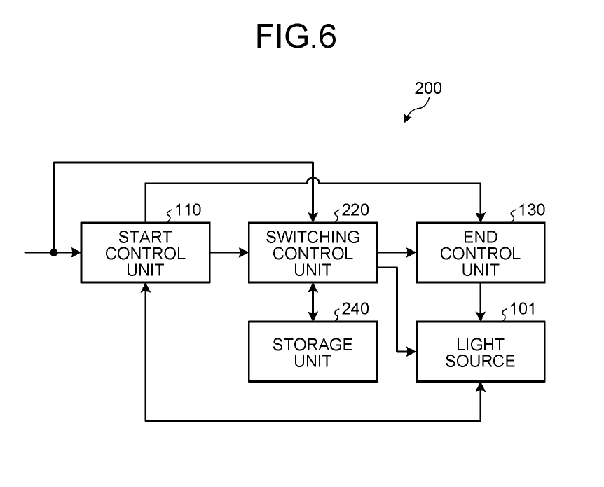

FIG. 6 is a block diagram illustrating an example of a configuration of an illumination apparatus according to a second embodiment. In the second embodiment, the same components as those of the first embodiment are denoted by the same reference numerals, and the detailed description thereof may be omitted. The functions, configurations, and processes of the second embodiment are the same as those of the first embodiment except for the below-described switching control unit 220 and storage unit 240.

As illustrated in FIG. 6, an illumination apparatus 200 is configured to include the light source 101, the start control unit 110, a switching control unit 220, the end control unit 130, and a storage unit 240. The second embodiment is different from the first embodiment in that information on illumination control which is desired by a user is stored in the storage unit 240 and the switching control is sequentially performed based on the stored information on the illumination control.

More specifically, in the case where the switching control unit 220 receives an illumination selection signal indicating that illumination is selected by user's manipulation during the performance of the switching control, the switching control unit 220 stores information on the switching control, which is currently performed, in the storage unit 240. Plural pieces of information on the switching control may be stored in the storage unit 240. In addition, the information on the switching control may also be overwritten.

In addition, in the case where the switching control unit 220 receives an instruction of starting the control of the light source 101 after the information on the switching control is stored in the storage unit 240, the switching control unit 220 sequentially performs the switching control based on the information on the switching control stored in the storage unit 240. In other words, in the embodiment, since a pattern of illumination appropriate for the user is stored, the light source 101 can be lighted up with respect to only the illumination appropriate for the user after the storing.

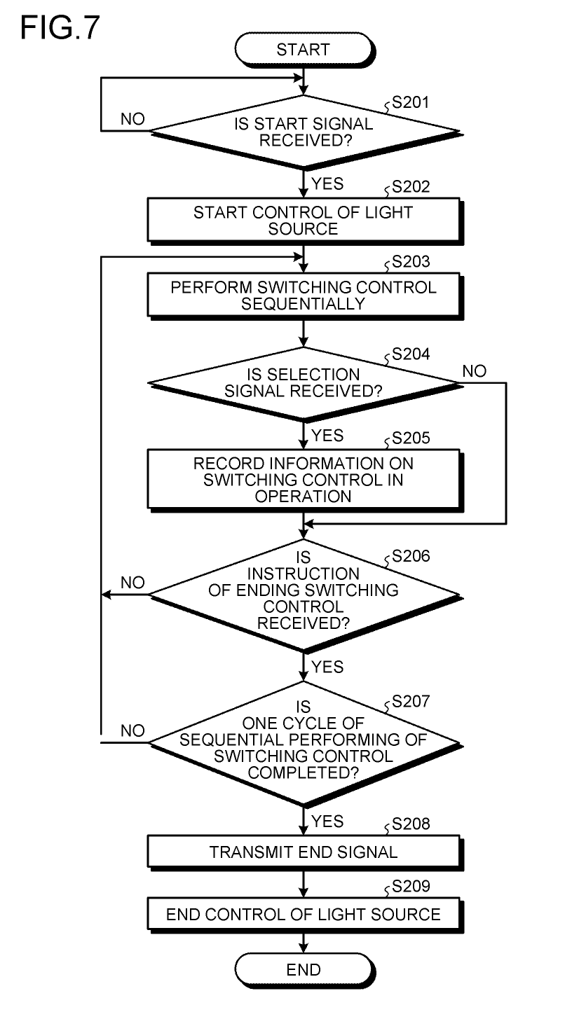

Next, a procedure of a light source control process according to the second embodiment will be described with reference to FIG. 7. FIG. 7 is a flowchart illustrating an example of the procedure of the light source control process according to the second embodiment. In addition, in some cases, the description of the same processes as those of the light source control process according to the first embodiment will not be provided. More specifically, the processes of Steps S201 to S203 are the same as those of Steps S101 to S103. In addition, the processes of Steps S206 to S209 are the same as those of Steps S104 to S107.

As illustrated in FIG. 7, in the case where the switching control unit 220 receives an illumination selection signal indicating that illumination is selected according to user's manipulation when the switching control unit 220 sequentially performs the switching control (Yes in Step S204), the switching control unit 220 stores information on the switching control which is currently performed in the storage unit 240 (Step S205). On the other hand, in the case where the switching control unit 220 does not receive the illumination selection signal when the switching control unit 220 sequentially performs the switching control (No in Step S204), the switching control unit 220 determines whether or not an instruction of ending the switching control is received through user's manipulation (Step S206).

In addition, in the case where the switching control unit 220 sequentially performs the switching control based on the information on the switching control stored in the storage unit 240, in the process of Step S103 or Step S203, the information on the switching control is acquired from the storage unit 240 and the corresponding illumination is output.

According to the embodiment, the pattern of the illumination appropriate for the user is stored, and the light source 101 is lighted up based on the stored pattern of the illumination, it is possible for the user to more speedily identify the difference in color with respect to the illuminated objects. For example, when the switching control is sequentially performed, the user selects a plurality of the patterns of the illumination of which the difference in color can be easily identified, and the user changes only the selected patterns of the illumination for comparison after the switching control is ended. In addition, for example, when the user is to distinguish between a cosmetic-applied skin and a bare skin, it is possible to select the pattern of illumination which is optimized to each portion of a face.

### Third Embodiment

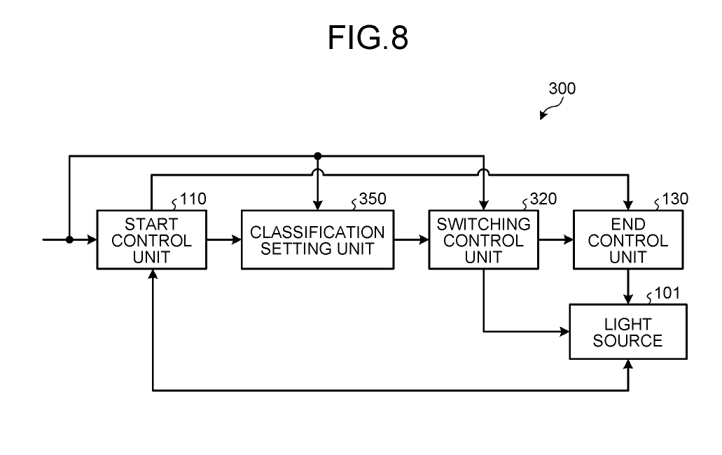

FIG. 8 is a block diagram illustrating an example of a configuration of an illumination apparatus according to a third embodiment. In the third embodiment, the same components as those of the first embodiment are denoted by the same reference numerals, and the detailed description thereof may not be provided. The functions, configurations, and processes of the third embodiment are the same as those of the first embodiment except for the below-described switching control unit 320 and classification setting unit 350.

As illustrated in FIG. 8, an illumination apparatus 300 is configured to include the light source 101, the start control unit 110, a switching control unit 320, the end control unit 130, and a classification setting unit 350. The third embodiment is different from the first embodiment in that classification of illuminated objects is set according to user's manipulation.

More specifically, the classification setting unit 350 receives and sets the classification of illuminated objects of the light source 101 according to user's manipulation. Next, the classification setting unit 350 notifies the set classification to the switching control unit 320. The setting of the classification of the illuminated objects is setting the use of illumination. In other words, although a plurality of the different spectral distributions which is set in advance according to the use of illumination are used in the above-described embodiments, in this embodiment, the use of illumination is set by the user. In other words, since the illumination which the user can easily identify is different according to the illuminated object, the classification of the illuminated objects is set by the user.

For example, the combination of the illuminated objects is as follows. The first illuminated object is set to be a “no-cosmetic-applied skin”, and the second illuminated object is set to be a “cosmetic-applied skin”. In addition, the first illuminated object is set to be “oxidized fruit juice”, and the second illuminated object is set to be “before-oxidization fruit juice”. In addition, the first illuminated object” is set to be a “thinly-painted portion of a car”, and the second illuminated object is set to be a “thickly-painted portion of a car”. With respect to the illuminated objects, the illumination is different so that the difference in color according to human perception is changed. The user selects the classification of the illuminated objects among the “cosmetic”, the “juice”, the “car”, and the like according to the use thereof. In addition, the classification of the illuminated objects is not limited to the above-described ones. In addition, the cosmetic type, the fruit type, the paint type, and the like may be set according to more detailed classification.

The switching control unit 320 sequentially performs the switching control according to the classification of the illuminated object of the light source 101 set by the classification setting unit 350. More specifically, the switching control unit 320 acquires a switching pattern of illumination light beams corresponding to the classification of the illuminated object set by the classification setting unit 350 and sequentially performs the switching control according to the acquired switching pattern. The switching pattern may be acquired from a memory installed in the illumination apparatus 300 or may be acquired from an external storage unit via a network.

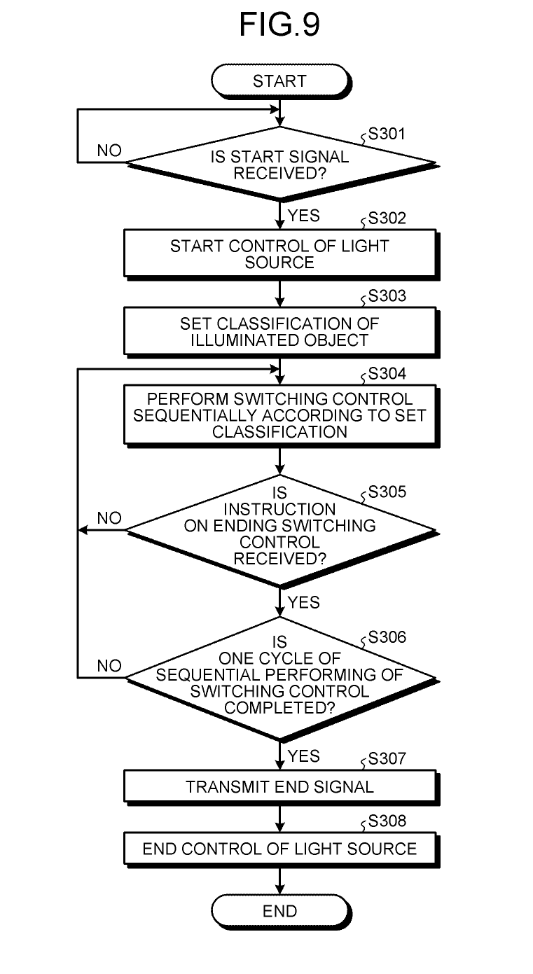

Next, a procedure of a light source control process according to the third embodiment will be described with reference to FIG. 9. FIG. 9 is a flowchart illustrating an example of the procedure of the light source control process according to the third embodiment. In addition, in some cases, the description of the same processes as those of the light source control process according to the first embodiment will not be provided. More specifically, the processes of Steps S301 and S302 are the same as those of Steps S101 and S102. In addition, the processes of Steps S305 to S308 are the same as those of Steps S104 to S107.

As illustrated in FIG. 9, the classification setting unit 350 receives and sets the classification of the illuminated object of the light source 101 according to user's manipulation (Step S303). The switching control unit 320 acquires a switching pattern of illumination light beams corresponding to the classification of the illuminated object of the light source 101 set by the classification setting unit 350 and sequentially performs the switching control according to the acquired switching pattern (Step S304).

According to the embodiment, since the classification of the illuminated object received according to the user's manipulation is set and the switching control corresponding to the set classification is sequentially performed, the light source 101 can be lighted up with very appropriate illumination according to the use thereof.

### Fourth Embodiment

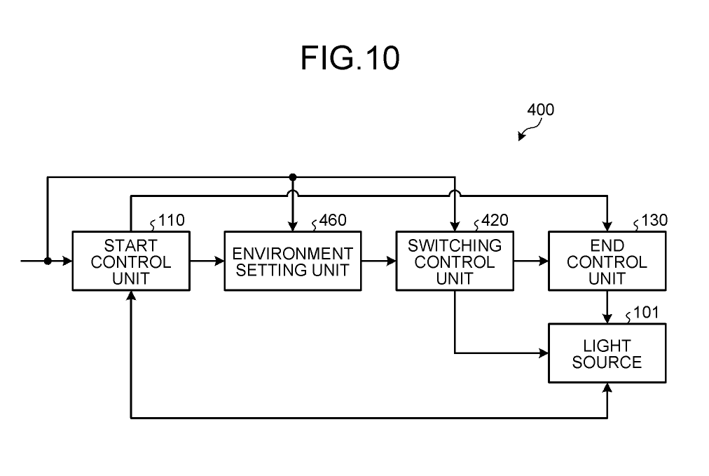

FIG. 10 is a block diagram illustrating an example of a configuration of an illumination apparatus according to a fourth embodiment. In the fourth embodiment, the same components as those of the first embodiment are denoted by the same reference numerals, and the detailed description thereof may not be provided. The fourth embodiment is the same as the first embodiment except for functions, configuration and processes of a switching control unit 420 and an environment setting unit 460 described hereinafter.

As illustrated in FIG. 10, an illumination apparatus 400 is configured to include the light source 101, the start control unit 110, a switching control unit 420, the end control unit 130, and an environment setting unit 460. The fourth embodiment is different from the first embodiment in that the environment where the light source 101 is used is set according to user's manipulation.

More specifically, the environment setting unit 460 receives and sets the environment where the light source 101 is used according to user's manipulation. Next, the environment setting unit 460 notifies the set environment to the switching control unit 420. The environment where the light source 101 is used is set according to indoor situation, outdoor situation, weather situation, or the like. The illumination which the user can select is standard illumination, which includes a standard illuminant or an auxiliary illuminant defined in accordance with JIS Z8720, a spectral distribution of a representative fluorescent lamp defined in accordance with JIS Z8719, and the like. For example, the user selects the environment where the light source 101 is to be used among the environments of the “light of the sun”, a “fluorescent lamp”, an “incandescent lamp”, and the like. In addition, in the case where the mirror 1 exemplified in the above-described embodiment is used, the illumination which is very appropriate under the set environment may be allowed to be requested in consideration of the reflection characteristics of the mirror 1.

The switching control unit 420 sequentially performs the switching control according to the environment where the light source 101 set by the environment setting unit 460 are used. More specifically, the switching control unit 420 acquires a switching pattern of illumination light beams corresponding to the environment where the light source 101 set by the environment setting unit 460 are used and sequentially performs the switching control according to the acquired switching pattern. The switching pattern may be acquired from a memory installed in the illumination apparatus 400 or may be acquired from an external storage unit via a network.

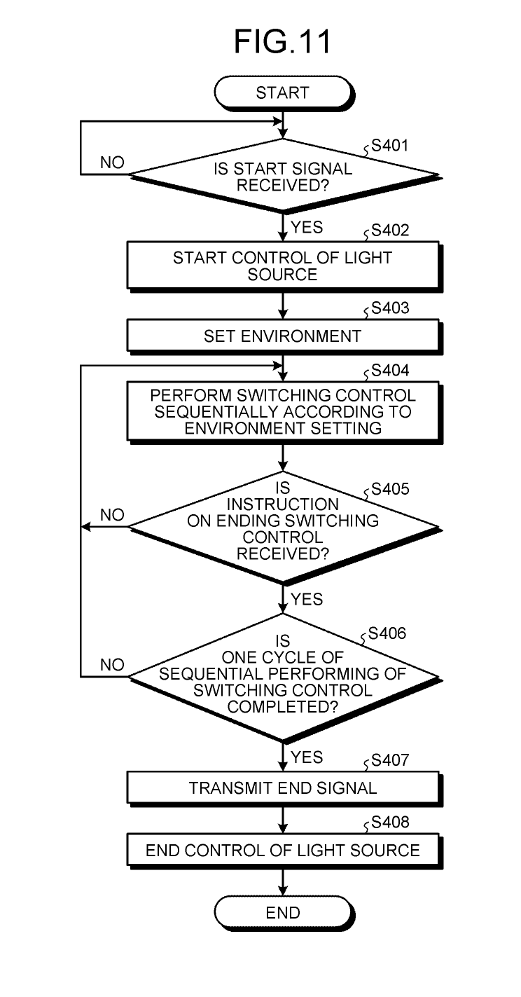

Next, a procedure of a light source control process according to the fourth embodiment will be described with reference to FIG. 11. FIG. 11 is a flowchart illustrating an example of the procedure of the light source control process according to the fourth embodiment. In addition, in some cases, the description of the same processes as those of the light source control process according to the first embodiment will not be provided. More specifically, the processes of Steps S401 and S402 are the same as those of Steps S101 and S102. In addition, the processes of Steps S405 to S408 are the same as those of Steps S104 to S107.

As illustrated in FIG. 11, the environment setting unit 460 receives and sets the environment where the light source 101 is used according to user's manipulation (Step S403). The switching control unit 420 acquires a switching pattern of illumination light beams corresponding to the environment where the light source 101 set by the environment setting unit 460 are used and sequentially performs the switching control according to the acquired switching pattern (Step S404).

According to the embodiment, since the environment where the light source 101 received according to the user's manipulation are used is set and the switching control corresponding to the environment is sequentially performed, even in the case where the environment where the light source 101 is used is different, the light source 101 can be lighted up with very appropriate illumination.

### Fifth Embodiment

Although the embodiments of the illumination apparatus are described hereinbefore, various forms different from the above-described embodiments may be embodied. Other embodiments according to (1) time of switching control and (2) configuration will be described.

(1) Time of Switching Control

In the above-described embodiments, although the case where the switching is performed with a constant time interval by sequentially performing the switching control is described, the time of switching by the switching control may be changed. More specifically, in the case where the switching control unit 120 receives an interval indication signal according to user's manipulation, the switching control unit 120 sequentially performs the switching control with a time interval different from the constant time interval. For example, in the case where the switching control unit 120 receives an interval indication signal indicating a time interval in the state where the switching control unit 120 sequentially performs the switching control with a constant time interval, the switching control unit 120 sequentially performs the switching control with the time interval indicated by the interval indication signal.

For example, in the case where the switching control unit 120 receives an interval indication signal indicating time extension in the state where the switching control unit 120 sequentially performs the switching control with a constant time interval, the switching control unit 120 sequentially performs the switching control with a time interval longer than the constant time interval. In addition, in the case where the switching control unit 120 receives an interval indication signal indicating time reduction in the state where the switching control unit 120 sequentially performs the switching control with a constant time interval, the switching control unit 120 sequentially performs the switching control with a time interval shorter than the constant time interval. In addition, the time extension or reduction of the time interval may be applied only to the switching control which is performed at the time of receiving the interval indication signal or may be applied to all switching control.

In addition, in the case where the switching control unit 120 does not sequentially perform the switching control with a constant time interval and receives a switching signal according to user's manipulation, the switching control unit 120 may sequentially perform the switching control. In addition, in the case where the switching control unit 120 receives a temporary stop signal according to user's manipulation in the state where the switching control unit 120 sequentially performs the switching control with a constant time interval or a time interval according to an interval indication signal, the switching control unit 120 may temporarily stop the sequential performing of the switching control. In the switching control unit 120 receives a restart signal according to user's manipulation after the temporary stoppage, the switching control unit 120 may restart the sequential performing of the temporarily-stopped switching control. During the temporary stoppage period, the illumination which is controlled at the time of the temporary stoppage is continuously performed. In addition, when the switching control is restarted, the illumination which is controlled at the time of the temporary stoppage may be performed, or the illumination according to the pattern of the restarted switching control may be performed.

(2) Configuration

In addition, information including a process procedure, a control procedure, specific terminologies, various data, various parameters, and the like written in the above-described document or illustrated in the drawings may be arbitrarily changed except for the case where the information is particularly written. For example, the classification of the illuminated object, the environment where the light source is used, or the like set according to the user's manipulation may be arbitrarily changed. In addition, the illustrated components of the illumination apparatus are conceptual ones, and thus, it is not necessary to configure the components with the same physical configuration as illustrated ones. In other words, distributive or collective specific forms of the apparatus is not limited to the illustrated ones, but the entire thereof or a portion thereof may be distributively or collectively configured with arbitrary units in terms of functions or physical configurations according to various burdens, use situations, or the like. For example, the start control unit 110 and the switching control unit 120 may be integrated as a “switching control starting unit” which receives the start signal and sequentially performs the switching control.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An illumination apparatus comprising:
a light source that emits at least two types of lights having different spectral distributions; and
a controller that starts controlling of the light source;
the controller that sequentially performs switching-controlling of pre-set lighting-up patterns of the light source so as to switch at least one of a combination of the lights having different spectral distributions of the light source and a combination of intensities of the light source in response to the start of the control of the light source; and
the controller that ends controlling of the light source after at least the switching-controlling of all the pre-set lighting-up patterns of the light source is performed.

2. The apparatus according to claim 1, wherein the controller sequentially performs the switching-controlling so that a difference in color perceived by a person between first and second illuminated objects having different colors as objects to be illuminated by the light source is changed.

3. The apparatus according to claim 1, wherein the controller stores information on the switching-controlling which is currently performed, in a storage unit when receiving an illumination selection signal.

4. The apparatus according to claim 3, wherein the controller sequentially performs the switching-controlling based on the information on the switching-controlling stored in the storage unit.

5. The apparatus according to claim 1, further comprising a classification setting unit that sets classification of an illuminated object of the light source,
wherein the controller sequentially performs the switching-controlling according to the set classification of the illuminated object of the light source.

6. The apparatus according to claim 1, further comprising an environment setting unit that sets environment where the light source is used,
wherein the controller sequentially performs the switching-controlling according to the set environment.

7. The apparatus according to claim 1, wherein
the controller starts controlling of the light source in a lighted-out state or a predetermined lighted-up state of illumination by the light source, and
the controller returns the illumination by the light source to the lighted-out state or the predetermined lighted-up state.

8. The apparatus according to claim 1, wherein the controller sequentially performs the switching-controlling with a constant time interval.

9. The apparatus according to claim 8, wherein the controller sequentially performs the switching-controlling with a time interval different from the constant time interval when receiving an interval indication signal.

10. The apparatus according to claim 1, wherein
the controller starts controlling of the light source when receiving a start signal, and
the controller ends controlling of the light source when receiving an end signal.

11. The apparatus according to claim 1, wherein the controller performs the switching-controlling when receiving a switching signal.

12. The apparatus according to claim 1, wherein
the controller temporarily stops the sequential performing of the switching-controlling when receiving a temporary stop signal, and
the controller restarts the sequential performing of the temporarily-stopped switching-controlling when receiving a restart signal.

13. The illumination apparatus according to claim 1, wherein the controller ends controlling of the light source when the switching-controlling is entirely performed.
